(19) United States
(12) Patent Application Publication
(10) Pub. No.: US 2011/0033738 A1
(43) Pub. Date: Feb. 10, 2011

(54) Economically Manufactured Battery Conversion Device

(76) Inventor: David H. Valentine, Sturgeon Bay, WI (US)

Correspondence Address: ABSOLUTE TECHNOLOGY LAW GROUP LLC, 3316 W. Wisconsin Avenue, MILWAUKEE, WI, 53208, US

(21) Appl. No.: 12/850,746

(22) Filed: Aug. 5, 2010

Related U.S. Application Data
(60) Provisional application No. 61/231,946, filed on Aug. 6, 2009.

(51) Int. Cl. H01M 2/10; B23P 19/04

(52) U.S. Cl. 429/99; 29/428

(57) ABSTRACT

The present invention is an apparatus and method which allows a smaller size battery to be adapted for use in a device which uses larger size batteries, thus saving energy costs. The apparatus can be mass produced from recycled in-expensive materials and is far less costly to manufacture than existing battery conversion devices.

### CROSS-REFERENCE TO RELATED APPLICATIONS

This application claims priority to U.S. Provisional Application No. 61/231,946 filed on Aug. 6, 2009.

### FIELD OF INVENTION

The present invention relates to the field of battery conversion and battery adapters and more particularly to the field of energy saving battery conversion devices.

### BACKGROUND

A D battery is a type of electrochemical cell, the largest in the D, C, AA, and AAA family. Each D cell is cylindrical with electrical contacts at each end; the positive end having a nub or bump. D cells are typically used in high current drain applications, such as in large flashlights, radio receivers and transmitters, portable entertainment systems, products with motors, safety systems, or other applications requiring extended run time. Rechargeable and non rechargeable versions are available. Non rechargeable cells are known as primary cells.

The D cell was standardized by ANSI as “13A” (alkaline) and is known internationally as LR20 (alkaline). The ANSI-13A is based on carbon-zinc chemistry and is marketed as a Heavy Duty cell. The standard D cell has physical dimensions of 60.5 mm (2.38 in), +/−1.0 mm (0.039 in), in length overall with a diameter of 33.2 mm (1.31 in), +/−1.0 mm (0.039 in).

There are many problems known in the art associated with the use of D batteries. First, D batteries are heavy and increase the weight of the device, which is inconvenient for devices that are handheld or frequently carried, especially when multiplied batteries are required. For example, the average 1.5V alkaline D battery weighs 148 grams, while the average AA battery weighs 23 grams.

In addition to being significantly heavier than AA batteries, D batteries are also larger, which makes carrying spare batteries more inconvenient. A D battery measures 34.2 mm in diameter and 61.5 mm in length, while an AA battery measures 14.5 mm in diameter and 50.5 mm in length.

D batteries are also more expensive than AA and AAA batteries and typically cost 2 to 3 times more than AA and AAA batteries.

AA batteries have become increasingly efficient with the development of new technologies, such as lithium batteries. For example, lithium batteries can produce twice the voltage of alkaline batteries and have a much longer life. In addition, there has been an increase in the availability of rechargeable battery options. AA and AAA batteries are the most common size rechargeable batteries, and some chargers are capable of charging only AA and AAA batteries. Because the initial cost of purchasing rechargeable batteries and a battery charger are greater than purchasing non-rechargeable batteries, the purchaser will want to purchase batteries and a charger for the size he or she most frequently uses, that is, AA and/or AAA.

Additionally, D batteries are also more prone to corrosion than smaller batteries. Battery acid is caustic and can injure skin, eyes and mucous membranes; this poses a particular hazard when D batteries are used in toys. The corrosion also damages devices by corroding contacts and wires within the devices, rendering them unusable.

Moreover, D batteries are often used in devices used infrequently (e.g., flashlights and toys). Even if never taken out of the original package, disposable (or “primary”) batteries can lose 8 to 20 percent of their original charge every year at a temperature of about 20° to 30° C. This is known as the “self discharge” rate and is due to non-current-producing “side” chemical reactions, which occur within the cell even if no load is applied to it. The rate of the side reactions is reduced if the batteries are stored at a low temperature, although some batteries can be damaged by freezing.

In addition, high or low temperatures may reduce battery performance. This will affect the initial voltage of the battery. For an AA alkaline battery this initial voltage is normally distributed around 1.5 volts.

AA batteries measure 51 mm in length (50.1 mm without the button terminal) and 13.5 to 14.5 mm in diameter (1.97×0.56 in). Traditional alkaline AA batteries have a mass of roughly 23 g (0.81 oz), Lithium AA batteries have a mass around 15 g (0.5 oz), and rechargeable NiMH batteries have a mass of about 31 g (1.1 oz).

The nominal output voltage of single-use AA batteries is 1.5 volts, while NiCd and NiMH rechargeable batteries have a nominal voltage of 1.2 V. Specialty batteries based on more unusual chemistries can run at a voltage as high as 1.6 V under load. The voltage of a AA battery is the same as a AAA battery, C cell or D cell. AA batteries, however, provide power for a longer period than AAA batteries, because their larger size allows them to store a greater mass of anode material which is consumed as it does electrical work. C and D cells, being larger 26.2 mm diameter, 50 mm length and 33.2 mm diameter, 60.5 mm length, respectively), last longer still; as a rough guide, the capacity of a battery scales linearly with its mass.

Primary (non-rechargeable) zinc-carbon AA batteries of 400 to 900 mAh capacity are commonly made using Leclanché cell technology. Zinc-chloride batteries of 1000 to 1500 mAh are often sold as “long life” or “heavy duty.” Alkaline batteries from 1700 mAh to almost 3000 mAh cost a little more, but last proportionally longer.

Single-use (i.e., non-rechargeable) lithium batteries are also available for high demand devices such as digital cameras, where their high cost is offset by longer running time between battery changes. As of 2008, the only 1.5 V lithium AA batteries, the “Ultimate Lithium,” are manufactured by Energizer, although AA-sized batteries with different nominal voltages are available from others. These should be used only in devices rated for the higher voltage.

It is desirable to have a battery conversion device that allows AA and/or AAA batteries to be used in devices that require large size batteries.

### GLOSSARY

As used herein, the term “conductive” means a material with movable electric charge capable of serving as a channel for electricity. Conductive materials may include, but are not limited to silver, copper, aluminum, gold, beryllium, and other metals.

As used herein, the ter “foam” refers to any lightweight cellular material, including but not limited to urethane foams, polyurethane, polyethylene, high density polyethylene, syntactic foams and other solid foams.

As used herein, the term “large size battery” refers to a cylindrical battery with a diameter greater than 26.2 mm, including but not limited to C and D batteries.

As used herein, the term “lightweight” means a battery conversion device with a total weight less than 148 g per large size battery the device is replacing.

As used herein, the term “parallel configuration” refers to batteries connected with like terminals together. When batteries are connected in a parallel configuration, the overall voltage remains the same, but capacity is increased.

As used herein, the term “permanently attached” means not removable. For example, a permanently attached end cap cannot be removed from a battery conversion device.

As used herein, the term “selectively attachable” means capable of being removed. For example, a selectively attached end cap can be attached to and removed from a battery conversion device.

As used herein, the term “series configuration” refers to batteries connected with the positive terminal of one battery joined to the negative terminal of a second battery. When batteries are connected in a series configuration, the overall voltage is increased, while capacity remains the same.

As used herein, the term “small size battery” means a cylindrical battery with a diameter less than 14.5 mm, including but not limited to AA and AAA batteries.

### SUMMARY OF THE INVENTION

The present invention is a battery conversion device which allows a smaller size standard battery to be used in devices that require a larger size battery. For example, an AA battery can be used to power a device that normally requires a D battery. In various embodiments, the device may be manufactured from recycled or “green” materials. The length of the device may also be adjusted to accommodate any number of batteries used in series by cutting with a scissors or other household instrument. The device is also sufficiently lightweight so that objects may be made buoyant by use of the device. Moreover, the device allows batteries to be easily removed or inserted without removing the device itself.

### BRIEF DESCRIPTION OF THE DRAWINGS

FIG. 1a illustrates an exemplary embodiment of a battery conversion device which holds two AA batteries in a series configuration and is adapted to receive the negative pole of the battery against a fixed end cap.

FIG. 1b illustrates an exemplary embodiment of a battery conversion device which holds a plurality of AA batteries in a parallel and series configuration.

FIG. 2 illustrates an exploded view of an exemplary embodiment of a battery conversion device which holds a plurality of AA batteries in a parallel and series configuration.

FIG. 3 illustrates an exemplary embodiment of a battery conversion device which holds a plurality of batteries in use in a flashlight.

FIG. 4 illustrates an exemplary embodiment of a battery conversion device in use in an audio device.

FIG. 5a illustrates a side perspective view of the dimensions and configuration of an exemplary embodiment of a machined, punched end cap for a battery conversation device.

FIG. 5b illustrates a top perspective view of the dimensions and configuration of an exemplary embodiment of a machined, punched end cap for a battery conversion device.

FIG. 6a illustrates a side perspective view of the dimensions and configuration of an exemplary embodiment of an assembled end cap for a battery conversion device.

FIG. 6b illustrates a top perspective view of the dimensions and configuration of an exemplary embodiment of an assembled end cap for a battery conversion device.

### DETAILED DESCRIPTION OF INVENTION

For the purpose of promoting an understanding of the present invention, references are made in the text to exemplary embodiments of a battery conversion device, only some of which are described herein. It should be understood that no limitations on the scope of the invention are intended by describing these exemplary embodiments. One of ordinary skill in the art will readily appreciate that alternate, but functionally equivalent materials, components, sizes, and designs may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural element.

Moreover, the terms “substantially” or “approximately” as used herein may be applied to modify any quantitative representation that could permissibly vary without resulting in a change in the basic function to which it is related.

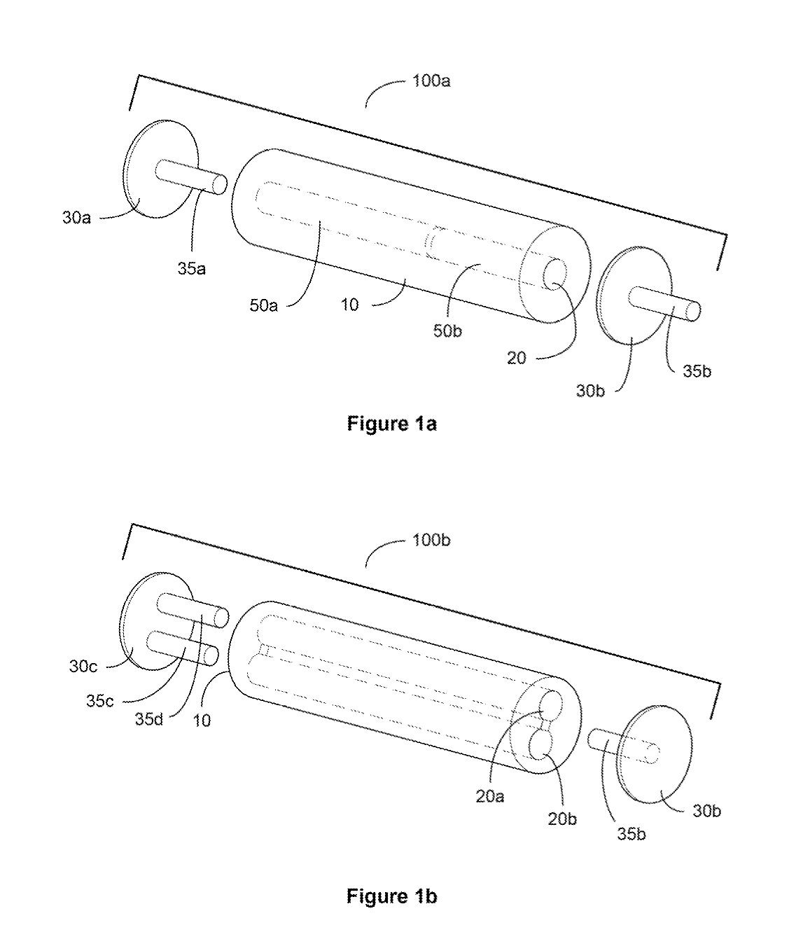

FIG. 1a illustrates an exemplary embodiment of battery conversion device 100 which holds two AA batteries 50a, 50b in a series configuration. Substantially solid foam tube 10 has an outer diameter which corresponds to the diameter of a battery. In the center of substantially solid foam tube 10 is aperture 20. In the embodiment shown, aperture 20 is slightly larger than the diameter of an AA battery to allow for easy removal of the batteries without having to remove battery conversion device 100 from the device in which it is placed.

In the embodiment shown, substantially solid foam tube 10 is comprised of polyethylene, a lightweight, recyclable material which is resistant to corrosion. In the embodiment shown, substantially solid foam tube 10 has no seams. In other embodiments, substantially solid foam tube 10 may have one or more seams and/or be made of one or more modular units.

At one end of substantially solid foam tube 10 is end cap 30a which will be permanently attached to substantially solid foam tube 10. Also visible in FIG. 1a, is optional end cap 30b for use when positive end of battery is against end cap 30a. In the embodiment shown, end cap 30b is identical to end cap 30a and is selectively attachable to substantially solid foam tube 10. End cap 30a is provided loose and may be placed so that it rests on the other end of substantially solid foam tube 10.

In the embodiment shown, end cap 30a will be permanently attached to solid foam tube 10 using adhesive. In various embodiments, end cap 30a may be permanently attached to solid foam tube 10 using another attachment means known in the art.

In the embodiment shown, end caps 30a, 30b are made of zinc coated steel. In other embodiments, end caps 30a, 30b are made of another type of metal or plated metal including, but not limited to steel coated with a material other than zinc (e.g., chrome), silver, copper, aluminum, gold, beryllium, or any other material which resists corrosion and has a similar conductivity.

Attached to end caps 30a, 30b are protuberances 35a, 35b which are affixed to one side of end caps 30a, 30b. In the embodiment shown, end cap 30a will be attached to substantially solid foam tube 10 so that protuberance 35a faces toward the center of substantially solid foam tube 10 and AA batteries 50a, 50b. In the embodiment shown, protuberance 35a makes up the difference in length between AA batteries 50a, 50b and D batteries.

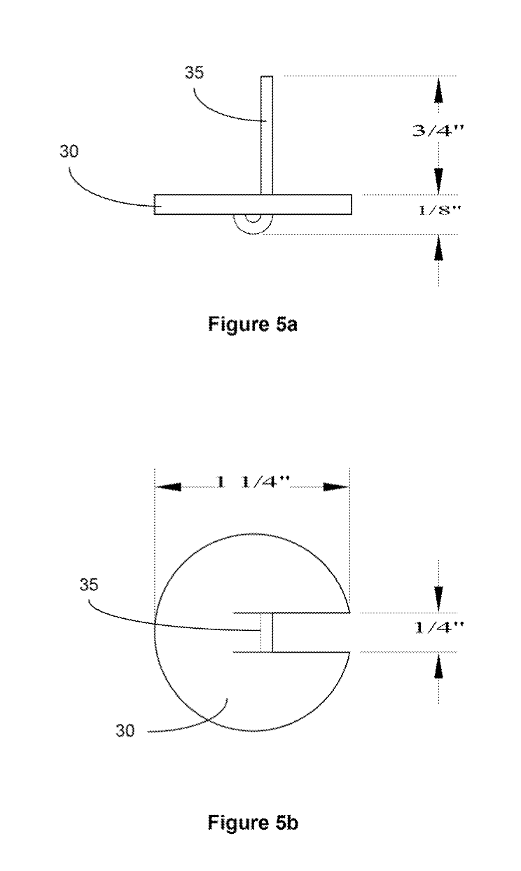

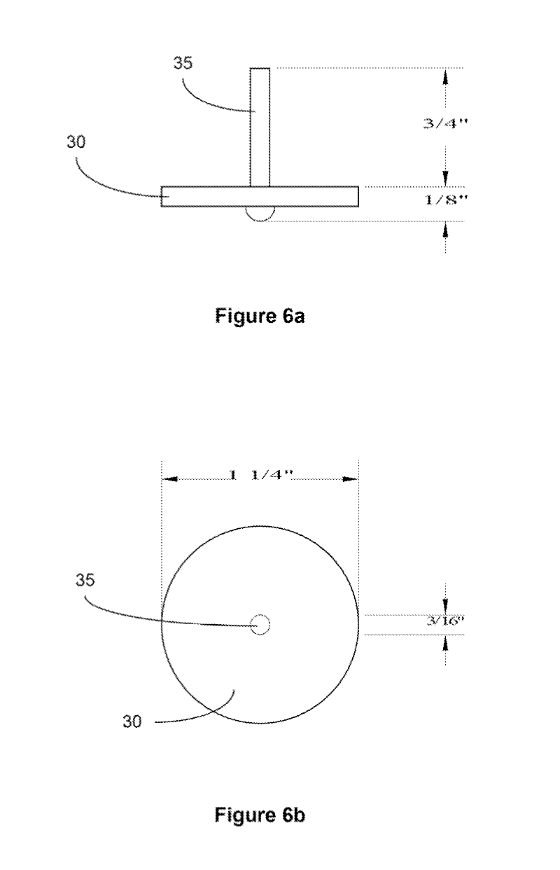

In the embodiment shown, protuberances 35a, 35b have a height of 19.05 mm (75 inches). On the opposite side of end caps 30a, 30b is a 3.175 mm (0.125 inch) protuberance (See FIGS. 5a and 6a). In the embodiment shown, end caps 30a, 30b are manufactured by machining and punching. In various other embodiments, end caps 30a, 30b may be manufactured by stamping, assembling and welding of multiple components, or other functionally equivalent process.

In the embodiment shown, protuberances 35a, 35b are made of a metal which is conductive. In other embodiments, more than one end cap and/or protuberance may be used.

FIG. 1b illustrates an exemplary embodiment of battery conversion device 100 which holds a plurality of AA batteries in a parallel and series configuration. Substantially solid foam tube 10 has an outer diameter which corresponds to the diameter of a D battery. Substantially solid foam tube 10 has two apertures 20a, 20b. In the embodiment shown, apertures 20a, 20b are connected. In the embodiment shown, apertures 20a, 20b are slightly larger than the diameter of an AA battery to allow for easy removal of the batteries without having to remove battery conversion device 100 in which it is placed.

In the embodiment shown, substantially solid foam tube 10 is comprised of polyethylene, a lightweight, recyclable material which is resistant to corrosion. In the embodiment shown, substantially solid foam tube 10 has no seams. In other embodiments, substantially solid foam tube 10 may have one or more seams and/or be made of one or more modular units.

At the ends of substantially solid foam tube 10 are end caps 30b, 30c which will be attached to the ends of substantially solid foam tube 10. In the embodiment shown, end caps 30b, 30c are made of coated steel. In other embodiments, end caps 30b, 30c are made of another type of metal which resists corrosion and has a similar conductivity (e.g., aluminum). In the embodiment shown, end cap 30c will be adhesively attached to one end of substantially solid foam tube 10 while end cap 30b is provided loose and will rest on the opposite end of substantially solid foam tube 10.

In the embodiment shown, end cap 30b is selectively removable so that the foam tube can be cut to any size or aligned with other substantially solid foam tubes. In various embodiments, end cap 30c, which will be permanently attached, may also be removed from substantially solid foam tube 10 by prying or cutting off. Substantially solid foam tube 10 may be cut with a scissors or other household object to accommodate more or fewer batteries aligned in a series configuration. For example, end cap 30c may be removed for use in certain four battery flashlights.

In the embodiment shown, end cap 30c will be attached to substantially solid foam tube 10 so that protuberances 35c, 35d face toward the center of substantially solid, foam tube 10. In the embodiment shown, protuberances 35b, 35c make up the difference in length between AA batteries and D batteries. In the embodiment shown, end cap 30b will be placed over the end of substantially solid foam tube 10 so that protuberances 35b extends into substantially solid foam tube 10 making contact between the batteries. In other embodiments, end cap 30b may be positioned so that protuberance 35b extends away from substantially solid foam tube 10 and the batteries. How end cap 30b is positioned depends upon the desired configuration of the batteries (e.g., three-battery or four-battery flashlights, four single batteries with alternating poles).

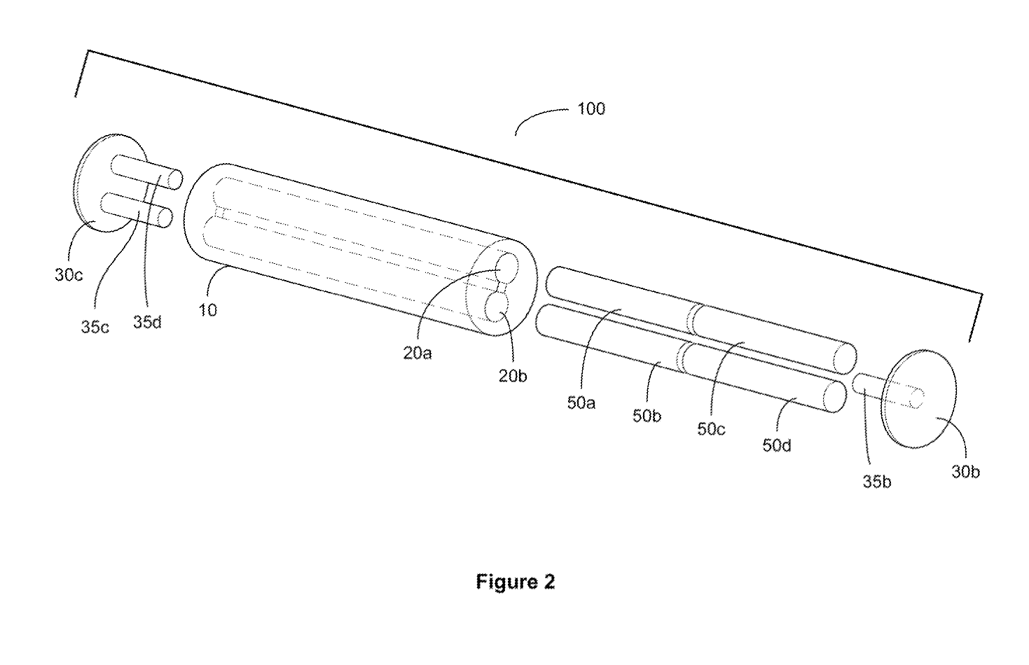

FIG. 2 illustrates an exploded view of an exemplary embodiment of battery conversion device 100 which holds four batteries 50a, 50b, 50c, 50d in a parallel and series configuration. Batteries 50a, 50c are in a series configuration and batteries 50b, 50d are in a series configuration. Substantially solid foam tube 10 has an outer diameter which corresponds to the diameter of a D battery. Substantially solid foam tube 10 has two apertures 20a, 20b which each hold two batteries in a series configuration. In the embodiment shown, apertures 20a, 20b are slightly larger than the diameter of an AA battery to allow for easy removal of the batteries without having to remove battery conversion device 100.

In the embodiment shown, substantially solid foam tube 10 is comprised of polyethylene, a lightweight, recyclable material which is resistant to corrosion. In the embodiment shown, substantially solid foam tube 10 has no seams. In other embodiments, substantially solid foam tube 10 may have one or more seams and/or be made of one or more modular units. In addition, substantially solid foam tube 10 may be sized to correspond to the diameter of a battery other than a D battery, such as a C battery.

At the ends of substantially solid foam tube 10 are end caps 30b, 30c. In the embodiment shown, end cap 30c is adhesively attached to one end of substantially solid foam tube 10 while end cap 30b is provided loose and rests on the opposite end of substantially solid foam tube 10.

In the embodiment shown, end cap 30c is attached to substantially solid foam tube 10 so that protuberances 35c, 35d face toward the center of substantially solid foam tube 10 and AA batteries 50a, 50b, 50c, 50d. In the embodiment shown, end cap 30b is placed over the end of substantially solid foam tube 10 so that protuberance 35b faces toward the center of substantially solid foam tube 10 and AA batteries 50a, 50b-50c, 50d. In the embodiment shown, end cap 30b is necessary to complete battery contact.

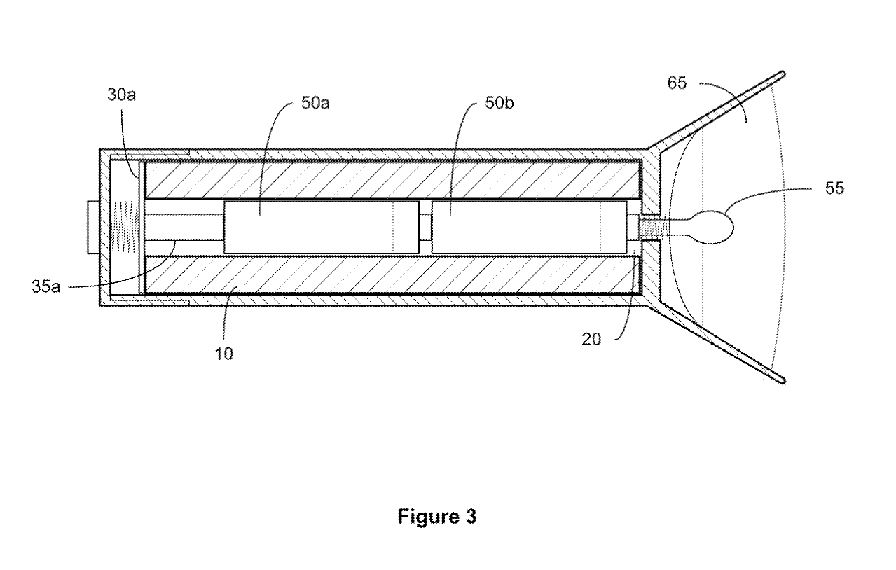

FIG. 3 illustrates an exemplary embodiment of battery conversion device 100 which holds two AA batteries 50a, 50b in a series configuration and is in use in flashlight 65. Substantially solid foam tube 10 has an outer diameter which corresponds to the diameter of a D battery. In the center of substantially solid foam tube 10 is aperture 20. In the embodiment shown, aperture 20 is slightly larger than the diameter of an AA battery to allow for easy removal of the batteries without having to remove battery conversion device 100. In the embodiment shown, flashlight 65 has a removable lamp end.

In the embodiment shown, substantially solid foam tube 10 is comprised of polyethylene, a lightweight, recyclable material which is resistant to corrosion. In the embodiment shown, substantially solid foam tube 10 has no seams. In other embodiments, substantially solid foam tube 10 may have one or more seams and/or be made of one or more modular units. In addition, substantially solid foam tube 10 may be sized to correspond to the diameter of a battery other than a D battery, such as a C battery.

At the end of substantially solid foam tube 10 is end cap 30a which is permanently attached to the end of substantially solid foam tube 10. In the embodiment shown, end cap 30b is not used; however, when battery conversion device 100 is used in various devices, end cap 30b may be placed on the top of substantially solid foam tube 10. End cap 30b would be held into place by the pressure of the device when closed. End cap 30b provides a contact for the spring, but may not be necessary if the spring contacts the negative end of the battery directly.

In the embodiment shown, protuberance 35a faces toward the center of substantially solid foam tube 10. In other embodiments, more than one end cap and/or protuberance may be used.

In the embodiment shown, battery conversion device 100 is inside flashlight 65. To install battery conversion device 100 in flashlight 65, lamp assembly 55 and D batteries are removed. Battery conversion device 100 is inserted into flashlight 65 with end having end cap 30a inserted first. AA batteries 50a, 50b are inserted into aperture 20 with “+” end facing outward. Lamp assembly 55 is then replaced.

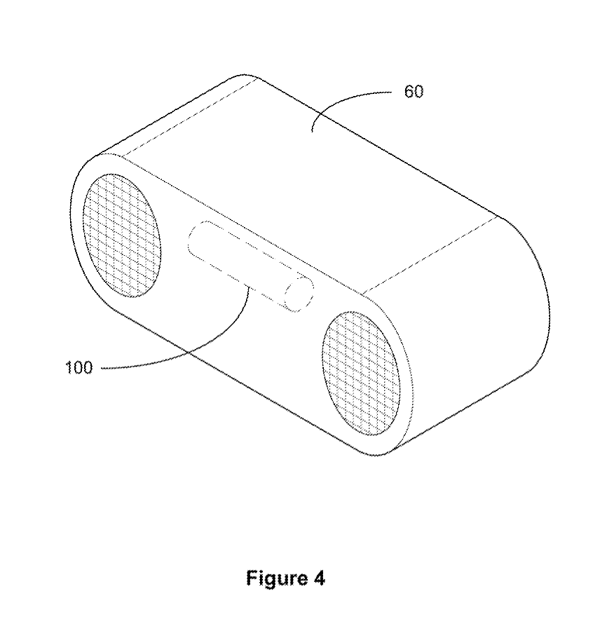

FIG. 4 illustrates an exemplary embodiment of battery conversion device 100 in use in audio device 60.

FIG. 5a illustrates a side perspective view of the dimensions and configuration of an exemplary embodiment of end cap 30 for battery conversation device 100. In the embodiment shown, protuberance 35 has a height of 19.05 mm (0.75 inches). In various embodiments, the width of protuberance 35 will vary depending on its use. On the opposite side of end cap 30 is a 3,175 mm (0.125 inch) protuberance.

In the embodiment shown in FIGS. 5a and 5b, end cap 30 is machined and punched. In various other embodiments, end cap 30 is manufactured by stamping, assembling and welding together, or by another functionally equivalent process. In the embodiment shown, protuberance 35 is made of a metal which is conductive. In other embodiments, more than one end cap and/or protuberance may be used.

FIG. 5b illustrates a top perspective view of the dimensions and configuration of an exemplary embodiment of end cap 30 for battery conversion device 100. In the embodiment shown, end cap 30 has a diameter of 31.75 mm (1¼ inches) and protuberance 35 has a width of 6.35 mm (¼ inch).

FIG. 6a illustrates a side perspective view of the dimensions and configuration of a second exemplary embodiment of end cap 30 and protuberance 35. In the embodiment shown in FIGS. 6a and 6b, end cap 30 is assembled by sliding a tubular component having a diameter of 4.7625 mm ( 3/16 inch) into a 4.7625 mm ( 3/16 inch) hole in the center of a metal component. The tubular component is then tack welded to end cap 30 forming protuberance 35. Tack welding results in a ⅛ inch protuberance on the side of end cap opposite protuberance 35.

FIG. 6b illustrates a top perspective view of the dimensions and configuration of a second exemplary embodiment of end cap 30. In the embodiment shown, end cap 30 has a diameter of 37.25 mm (1¼ inches) and protuberance 35 has a diameter of 4.7625 mm ( 3/16 inch).

What is claimed is:

1. An apparatus comprised of:
a foam tubular member having an outer diameter greater than 26.2 mm adapted to receive and secure at least two batteries having diameters less than 14.5 mm, said foam tubular member adapted to receive a first conductive end cap having an inner surface, outer surface, and a protuberance affixed to said outer surface and a second conductive end cap having an inner surface, outer surface, and a protuberance affixed to said outer surface;
wherein said first conductive end cap is attached to a first end of said foam tubular structure and said second conductive end cap is attached to a second end of said foam tubular member.

2. The apparatus of claim 1 wherein said first conductive end cap is permanently attached to said foam tubular member and said second conductive end cap is selectively attached to said foam tubular member.

3. The apparatus of claim 1 wherein said outer diameter is greater than 33.2 mm.

4. The apparatus of claim 1 wherein said at least two batteries are connected in parallel configuration.

5. The apparatus of claim 1 wherein said at least two batteries are connected in series configuration.

6. The apparatus of claim 1 wherein said foam tubular member is greater than 50 mm in length.

7. The apparatus of claim 1 wherein said foam tubular member is greater than 60.5 mm in length.

8. The apparatus of claim 1 wherein said foam tubular member is adapted to be cut to various sizes.

9. The apparatus of claim 1 wherein said foam tubular member is made from polyethylene.

10. The apparatus of claim 1 wherein said foam tubular member is made from a material selected from a group consisting of polyethylene, polyurethane, high density polyethylene, and synthetic foam.

11. The apparatus of claim 1 wherein said foam tubular member is hollow.

12. The apparatus of claim 1 wherein said first conductive end cap and said second conductive end cap are comprised of a material selected from a group consisting of coated steel, silver, copper, aluminum, gold, and beryllium.

13. An apparatus comprised of:
a lightweight foam tubular member having an outer diameter greater than 26.2 mm adapted to receive and secure at least two batteries having diameters less than 14.5 mm, said foam tubular member adapted to receive a conductive end cap having an inner surface, outer surface, and a protuberance affixed to said outer surface;
wherein said conductive end cap is permanently attached to said foam tubular member so that said protuberance faces toward the center of said foam tubular member.

14. The apparatus of claim 13 wherein said foam tubular member secures two batteries and weighs less than 148 g.

15. The apparatus of claim 13 wherein said at least two batteries are connected in parallel configuration.

16. The apparatus of claim 1 wherein said at least two batteries are connected in series configuration.

17. The apparatus of claim 13 wherein said conductive end cap is comprised of a material selected from a group consisting of coated steel, silver, copper, aluminum, gold, and beryllium.

18. A method of manufacturing a battery conversion apparatus comprising the steps of:
creating a foam tubular member with an outer diameter greater than 26.2 m from at least one modular unit, said foam tubular member having a first end and a second end;
adapting said foam tubular member to receive and secure at least two batteries having diameters less than 14.5 mm;
creating a first conductive end cap and a second conductive end cap, each of first conductive end cap and said second conductive end cap having a protuberance; and
attaching said first conductive end cap to said first end of said foam tubular member so that said protuberance extends into said foam tubular member.

19. The method of claim 18 which further includes placing said second conductive end cap on said second end of said foam tubular member so that said protuberance extends away from said foam tubular member.
